(19) United States
(12) Patent Application Publication
(10) Pub. No.: US 2024/0239044 A1
(43) Pub. Date: Jul. 18, 2024

(54) ROTATABLE RECEIVER FOR A THREE-DIMENSIONAL PRINTER HEAD

(71) Applicant: Essentium IPCO, LLC, Pflugerville, TX (US)

(72) Inventors: Alex Stockton, Austin, TX (US); William Jack MacNeish, III, Santa Ana, CA (US)

(21) Appl. No.: 18/556,729

(22) PCT Filed: Apr. 25, 2022
(86) PCT No.: PCT/US22/26139

§ 371 Date: Oct. 23, 2023

Related U.S. Application Data
(60) Provisional application No. 63/180,267, filed on Apr. 27, 2021.
(60) Provisional application No. 63/180,268, filed on Apr. 27, 2021.

(51) Int. Cl. B29C 64/209; B29C 64/232; B29C 64/241; B33Y 30/00

(52) U.S. Cl. CPC B29C 64/209; B29C 64/232; B29C 64/241; B33Y 30/00

(57) ABSTRACT

A three-dimensional printer head includes a receiver assembly including a main body divided into a front section and a rear section. The front section of the main body is independently rotatable of the rear section of the main body. The main body of the receiver assembly defines a feed opening, a discharge opening, and a passageway that extends between the feed opening and the discharge opening of the main body.

### CROSS-REFERENCE TO RELATED APPLICATIONS

This application claims priority to U.S. Application No. 63/180,267 filed on Apr. 27, 2021 and U.S. Application No. 63/180,268 filed on Apr. 27, 2021.

### FIELD

The present disclosure is directed to a rotatable receiver for a three-dimensional printer head.

### BACKGROUND

The statements in this section merely provide background information related to the present disclosure and may or may not constitute prior art.

Three-dimensional printers create three dimensional components based on computer generated models by depositing a feedstock. The feedstock, which may be a thermoplastic material, is deposited by a printer head. In particular, the printer head includes a nozzle that heats and deposits the feedstock material. The feedstock material may be in the form of a filament, which is fed into the printer head through a receiver that is located in an upper portion of the printer head. The receiver orients the filament and guides the filament towards a drive hob of the printer head. Specifically, the filament exits the receiver and is pinched between the drive hob and an idle hob of the printer head, where the drive hob urges the filament into the nozzle of the printer head.

Sometimes the filament becomes misplaced and migrates to an area either in front of or behind the drive hob and the idle hob such that the filament is no longer engaged between the two hobs. If this occurs, an operator may need to manually re-position the filament. In one approach to ensure that the filament is correctly fed into the drive hob section of the printer head, the diameter of an opening in the receiver may be reduced. However, reducing the diameter of the receiver may also have drawbacks. For example, in some instances a heated portion of the filament may be extracted from the nozzle and retracted back into the printer head. It is to be appreciated that heating the filament causes the filament to swell or expand. As a result, when the diameter of the opening in receiver is reduced, a filament that was previously heated by the nozzle may not be able retract back into the receiver.

Thus, while current three-dimensional printer heads achieve their intended purpose, there is a need for a new and improved approaches for feeding the filament into the nozzle.

### SUMMARY

According to several aspects, a three-dimensional printer head is provided, and includes a receiver assembly including a main body divided into a front section and a rear section. The front section of the main body is independently rotatable of the rear section of the main body. The main body of the receiver assembly defines a feed opening, a discharge opening, and a passageway that extends between the feed opening and the discharge opening of the main body.

According to several aspects, a three-dimensional printer head is disclosed and includes a nozzle and a z-axis plate assembly including a plate, where the nozzle is attached to the plate. The three-dimensional printer head also includes a vertical height adjustment system configured to move the nozzle in an upward vertical direction. The vertical height adjustment system includes a lifting bar configured to travel along a total distance to adjust a vertical position of the nozzle and a plurality of tangs that are part of the z-axis plate. Each tang includes an upper stop and a lower stop that define the total distance that the lifting bar travels.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

FIG. 1 is a perspective view of an aspect of a three-dimensional printer head of the present disclosure;

FIG. 2 is a cross-sectioned view of the three-dimensional printer head taken along section line A-A in FIG. 1 of the present disclosure;

FIG. 3 is an elevated front perspective view of a receiver assembly that is part of the printer head of the present disclosure;

FIG. 4 is a rear perspective view of the receiver assembly of the present disclosure;

FIG. 5 is a bottom view of the receiver assembly of the present disclosure;

FIG. 6 is a cross-sectioned view of the receiver assembly taken along section line B-B seen in FIG. 3 of the present disclosure;

FIG. 7 is a cross-sectioned view of the receiver assembly taken along section line C-C in FIG. 3 of the present disclosure;

FIG. 8 is a cross-sectioned view of the receiver located within the printer head, where an insert is included within the receiver of the present disclosure;

FIGS. 9A and 9B illustrate the two sections that cooperate together to define a main body of the receiver of the present disclosure;

FIG. 10 a perspective view of an aspect of a three-dimensional printer head and support table of the present disclosure;

FIG. 11 a perspective view of the three-dimensional printer head shown in FIG. 10, illustrating the vertical height adjustment system of the present disclosure;

FIG. 12 is a perspective view of the nozzle of printer head of the present disclosure;

FIG. 13 is a perspective view of the nozzle assembled to a z-axis plate of the present disclosure;

FIG. 14 is another perspective view of the print assembled to a z-axis plate of the present disclosure;

FIG. 15 is another perspective view of the nozzle assembled to the z-axis plate of the present disclosure;

FIG. 16 is an enlarged cross-sectioned view of a side wall of the z-axis plate, which includes a tang holding a lifting bar of the present disclosure;

FIG. 17 illustrates the lifting bar threadingly engaged with an adjustment screw of the present disclosure;

FIG. 18 is a top view of the adjustment screw seen in FIG. 17 according to the present disclosure; and

FIG. 19 is a cross-sectioned view of a sensor assembly according to the present disclosure.

### DETAILED DESCRIPTION

The following description is merely exemplary in nature and is not intended to limit the present disclosure, application, or uses.

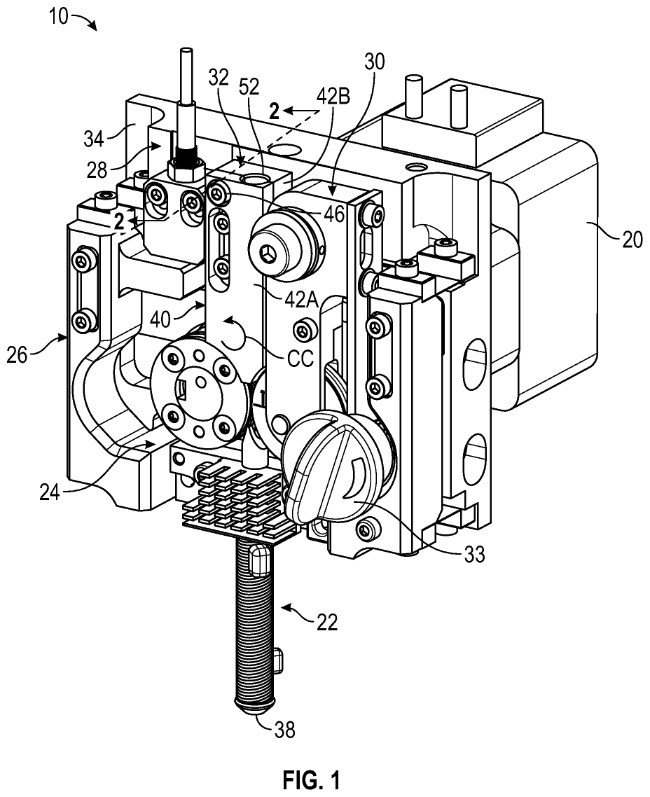

The present disclosure is directed to a printer head including a rotatable receiver. Referring now to FIG. 1, a three-dimensional printer head 10 for a three-dimensional printer is illustrated. The printer head 10 includes a motor housing 20 containing a drive motor (not shown), a nozzle 22, a feed system 24, a z-axis plate assembly 26, a sensor assembly 28, an idle assembly 30, a receiver assembly 32, an adjustment knob 33, and a feed plate 34. The receiver assembly 32 may receive a filament (not shown) from a filament source. In aspects, the filament includes thermoplastic materials, or materials that are at least partially thermoplastic, such as thermoplastic copolymers that may include cross-linked co-polymers. The filament is guided through the receiver assembly 32 and towards the feed system 24 of the printer head 10. The feed system 24 pulls or advances the filament through the printer head 10 and towards the nozzle 22. The nozzle 22 heats the filament, and the heated filament exits the printer head 10 through a discharge opening 38 of the nozzle 22.

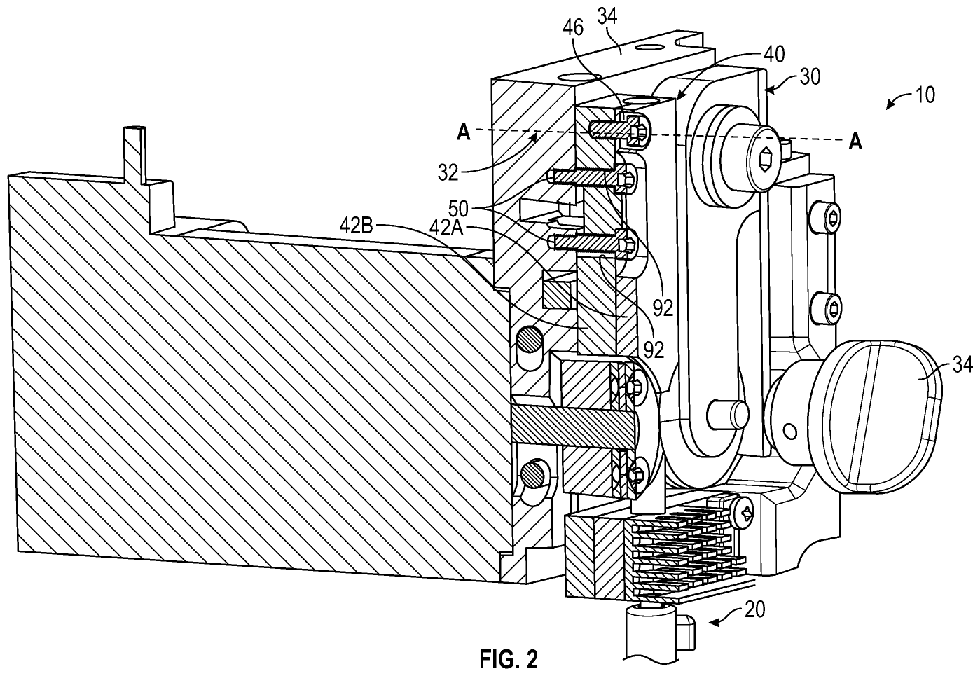

FIG. 2 is a cross-sectioned view of the printer head 10 taken along section line A-A in FIG. 1. Referring to FIGS. 1 and 2, the receiver assembly 32 includes a main body 40 that is divided into a front section 42A and a rear section 42B, where the front section 42A and the rear section 42B cooperate together to create the main body 40. Referring to FIG. 2, the front section 42A of the main body 40 is rotatably secured to the rear section 42B of the main body 40 by a mechanical fastener 46. As explained below, the front section 42A is independently rotatable of the rear section 42B of the main body 40 of the receiver assembly 32 about an axis of rotation A-A, where the axis of rotation A-A coincides with the mechanical fastener 46. One or more mechanical fasteners 50 secure the rear section 42B of the main body 40 of the receiver assembly 32 to the feed plate 34.

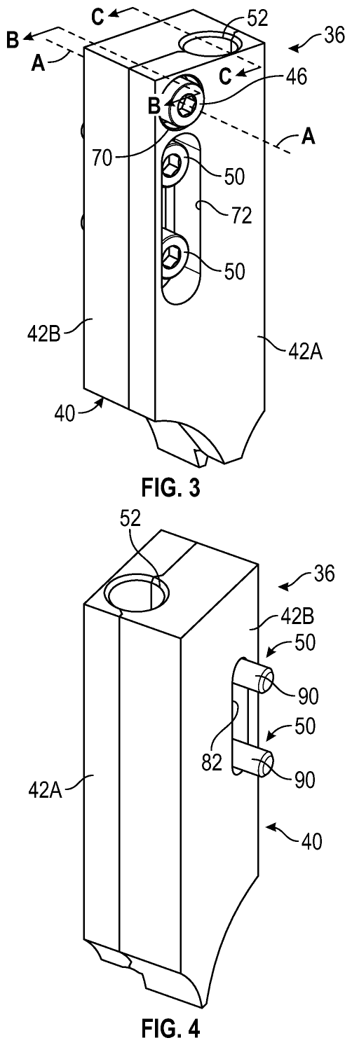

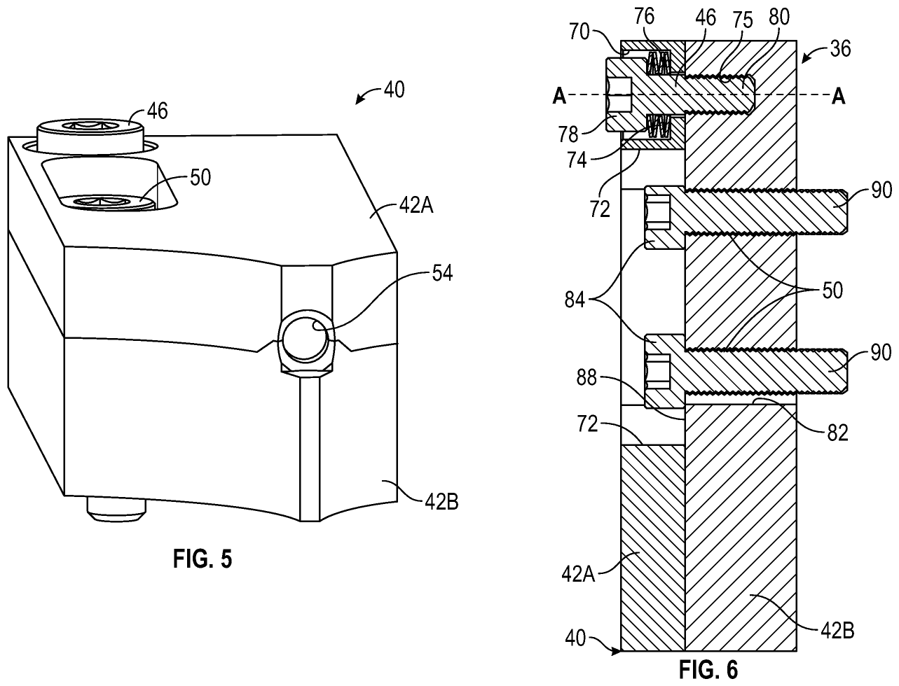

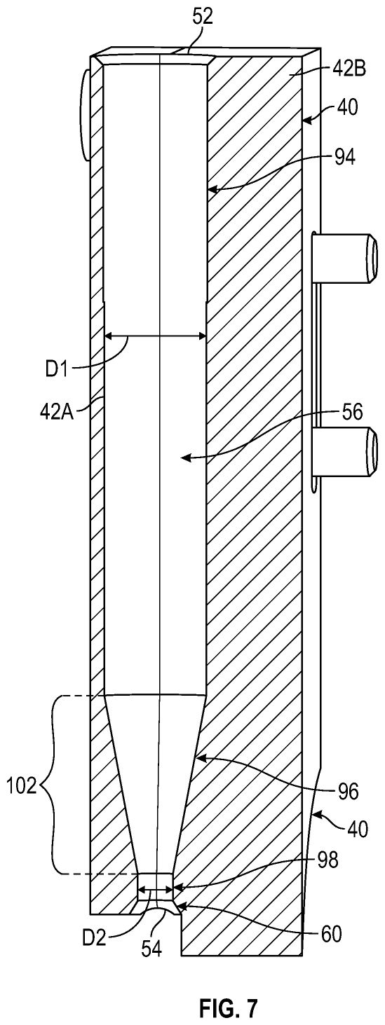

FIG. 3 is a front perspective view of the main body 40 of the receiver assembly 32, FIG. 4 is a rear perspective view of the main body 40, FIG. 5 is a bottom view of the main body 40, FIG. 6 is a cross-sectioned view of the main body 40 taken along section line B-B seen in FIG. 3, and FIG. 7 is a cross-sectioned view of the main body 40 taken along section line C-C in FIG. 3. Referring specifically to FIGS. 3, 5, and 7, the two sections 42A and 42B of the main body 40 of the receiver assembly 32 cooperate together to define a feed opening 52, a discharge opening 54, and a passageway 56 that extends between the feed opening 52 and the discharge opening 54 of the main body 40. As seen in FIG. 7, the passageway 56 of the main body 40 varies in diameter to guide a filament (not shown in the figures) towards the discharge opening 54.

In some instances, a heated portion of the filament (not shown in the figures) may be extracted from the nozzle 22 (seen in FIG. 1) and retracted back into the printer head 10. However, since the filament has been heated, the filament may swell or increase in diameter. In order to accommodate for the swollen or enlarged filament, the passageway 56 of the main body 40 of the receiver assembly 36 includes a diverging portion 60 (seen in FIG. 7) located immediately upstream of the discharge opening 54, which is described in greater detail below. Furthermore, referring to FIGS. 1 and 3, the front section 42A of the main body 40 of the receiver assembly 32 may rotate about the axis of rotation A-A in a counterclockwise direction CC (seen in FIG. 1) to accommodate a swollen filament attempting to re-enter the discharge opening 54 of the main body 40.

Referring to FIGS. 3 and 6, the front section 42A of the main body 40 of the receiver assembly 32 includes a countersunk aperture 70 for receiving the mechanical fastener 46 and a slotted opening 72 for receiving the one or more mechanical fasteners 50. As seen in FIG. 6, the countersunk aperture 70 defines a shelf 74, where one or more biasing members 76 are seated against the shelf 74 of the countersunk aperture 70. In the embodiment as shown in the figures, the biasing members 76 are disk springs, however, it is to be appreciated that other biasing mechanisms may be used as well. The biasing members 76 are secured in place within the countersunk aperture 70 by a head 78 of the mechanical fastener 46. The biasing members 76 exert a biasing force upon the front section 42A of the main body 40 in a direction opposite to the direction of rotation the front section 42A of the main body 40. For example, in the embodiment as illustrated, the biasing members 76 exert a biasing force in a clockwise direction. Accordingly, when the front section 42A of the main body 40 rotates about the axis of rotation A-A in the counterclockwise direction CC (FIG. 1), the biasing members 76 exert the biasing force upon the front section 42A of the main body 40, thereby urging the front section 42A back to an original position.

Continuing to refer to FIGS. 3 and 6, the rear section 42B of the main body 40 of the receiver assembly 32 includes a blind aperture 75 for receiving a shank 80 of the mechanical fastener 46 and an opening 82 for receiving the one or more mechanical fasteners 50. As seen in FIG. 6, the heads 84 of the fasteners 50 abut against a front surface 88 of the rear section 42B of the main body 40 to secure the rear section 42B to the feed plate 34 of the printer head 10 (FIG. 1). As seen in FIG. 4, the shanks 90 of the fasteners 50 pass through the opening 82 of the rear section 42B of the main body 40 of the receiver assembly 32 and are received by openings 92 located within the feed plate 34 (seen in FIG. 2) of the printer head 10. Thus, the rear section 42B of the main body 40 of the receiver assembly 36 remains fixed to the printer head 10, while the front section 42A of the main body 40 is free to rotate about the axis of rotation A-A.

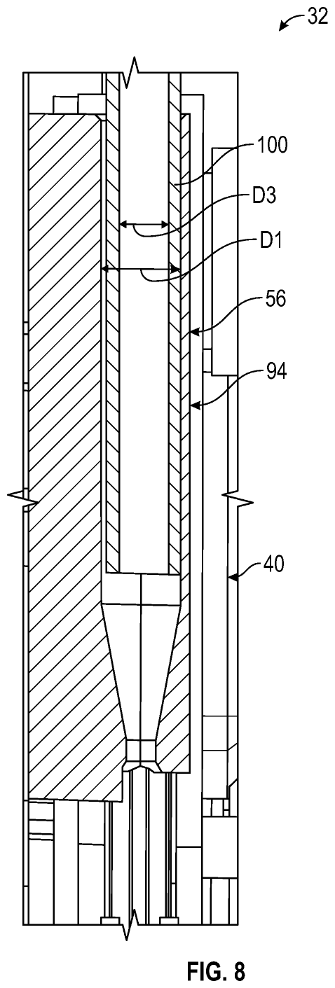

Referring to FIG. 7, the passageway 56 of the main body 40 includes an entry portion 94, a converging portion 96, a reduced diameter portion 98, and the diverging portion 60. The entry portion 94 of the passageway 56 of the main body 40 of the receiver assembly 32 is located directly downstream of the feed opening 52 and includes a uniform first diameter D1. In one embodiment, an insert 100 (seen in FIG. 8) may be placed within the entry portion 94 of the passageway 56, where the insert 100 includes an internal diameter D3 that is less than the uniform diameter D1 entry portion 94 of the passageway 56. The insert 100 may be provided to further guide a filament through the receiver assembly 36.

Referring back to FIG. 7, the converging portion 96 of the passageway 56 is located immediately downstream of the entry portion 94 and defines a tapered section 102 that further guides a filament through the passageway 56 of the receiver assembly 36. The dimensions of the tapered section 102 are selected to reduce or prevent the filament from buckling. In an embodiment, the tapered section 102 is angled at about a 10 degree angle. The reduced diameter portion 98 of the passageway 56 is located immediately downstream of the converging portion 96, and includes a uniform second diameter D2, where the first diameter D1 of the entry portion 94 of the passageway 56 is greater than the second diameter D2 of the reduced diameter portion 98 of the passageway 56.

The diverging portion 60 of the passageway 56 is located immediately downstream of the reduced diameter portion 98 of the passageway 56, and immediately upstream from the discharge opening 54 of the main body 40 of the receiver assembly 36. The diverging portion 60 of the passageway 56 is sized to allow a filament that has expanded due to heating by the nozzle 22 (FIG. 1) to travel back into the passageway 56. In one non-limiting embodiment, the diverging portion 60 of the passageway 56 is angled at about a 45 degree angle. The angle of the passageway 56 is selected so as to allow the front section 42A of the main body 40 of the receiver assembly 36 to rotate without requiring a large transition zone.

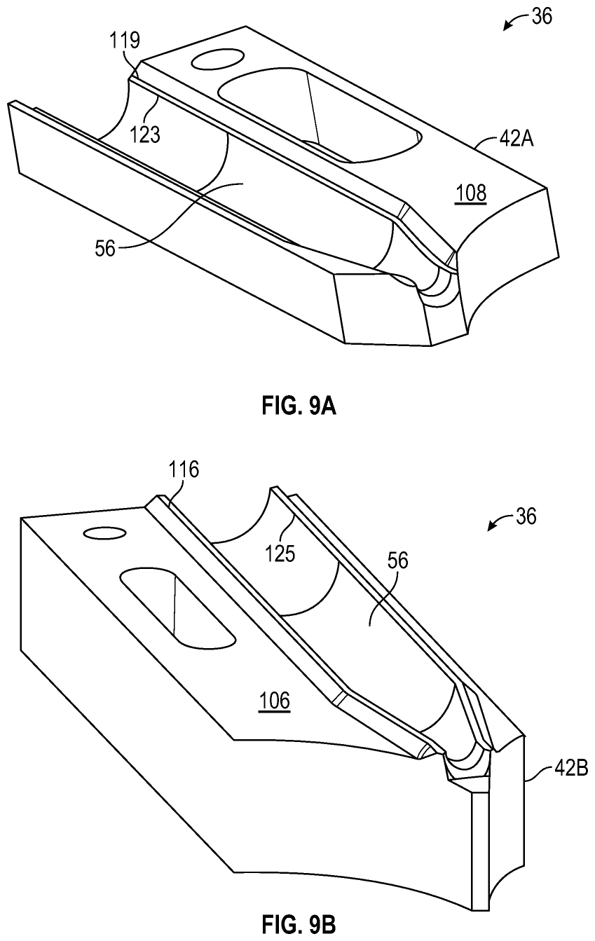

In one embodiment, the two sections 42A and 42B of the main body 40 of the receiver assembly 36 include one or more locating features to ensure that the two sections 42A and 42B fit together consistently. FIG. 9A is an illustration of the front section 42A of the main body 40, where an inner surface 108 including the passageway 56 is visible. Similarly, FIG. 9B illustrates an inner surface 106 of the rear section 42B of the main body 40. Referring now to FIGS. 9A and 9B, in one embodiment, the front section 42A of the main body 40 includes one or more grooves 119 that are shaped to receive one or more corresponding ribs 116 of the rear section 42B of the main body 40. In the exemplary embodiment as shown in the figures, the grooves 119 are located along an outer periphery 124 of the passageway 56 of the front section 42A of the main body 40, and the ribs 116 are located along an outer periphery 125 of the passageway 56 of the rear section 42B of the main body 40. When the two sections 42A, 42B of the main body 40 are joined together, the grooves 119 of the front section 42A receive the ribs 116 of the rear section 42B of the main body 40, thereby preventing relative movement between the front section 42A and the rear section 42B.

Referring generally to the figures, the disclosed printer head provides various technical effects and benefits. Specifically, the disclosed printer head includes an improved receiver assembly that is able to accommodate a swollen or enlarged filament that is retracted from the nozzle. Specifically, the front section of the main body of the receiver assembly may rotate about an axis to accommodate a swollen filament attempting to re-enter the discharge opening of the receiver assembly. Furthermore, the front section of the main body is also biased, and therefore may return back to its original position as well. The disclosed receiver assembly also includes a passageway including a diverging portion located immediately upstream of the discharge opening of the receive assembly, where the diverging portion is sized to accommodate a swollen filament as well.

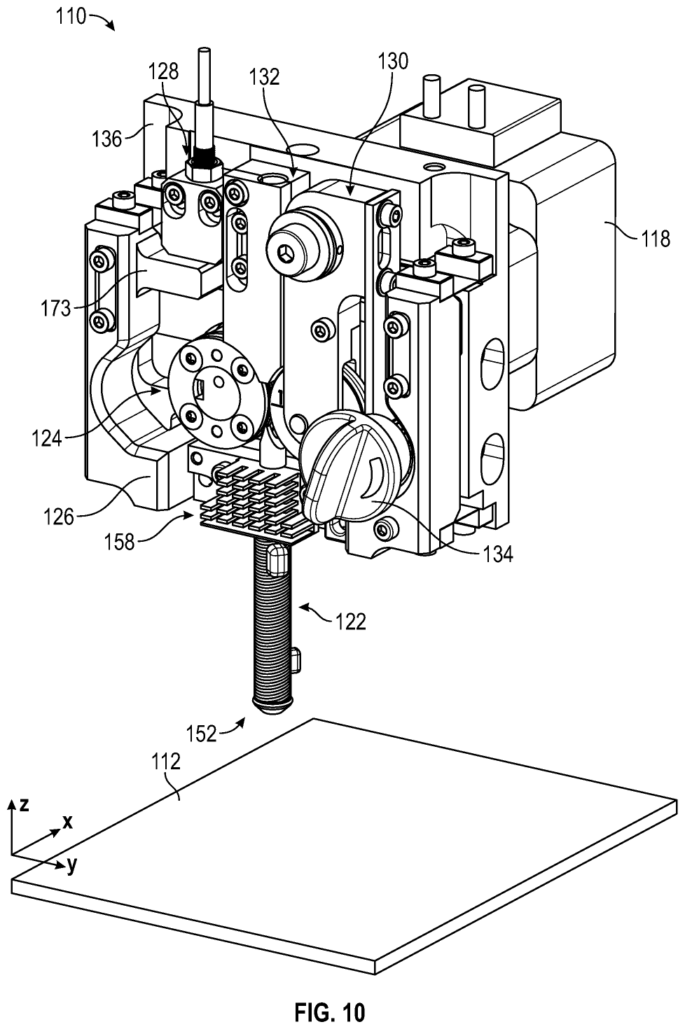

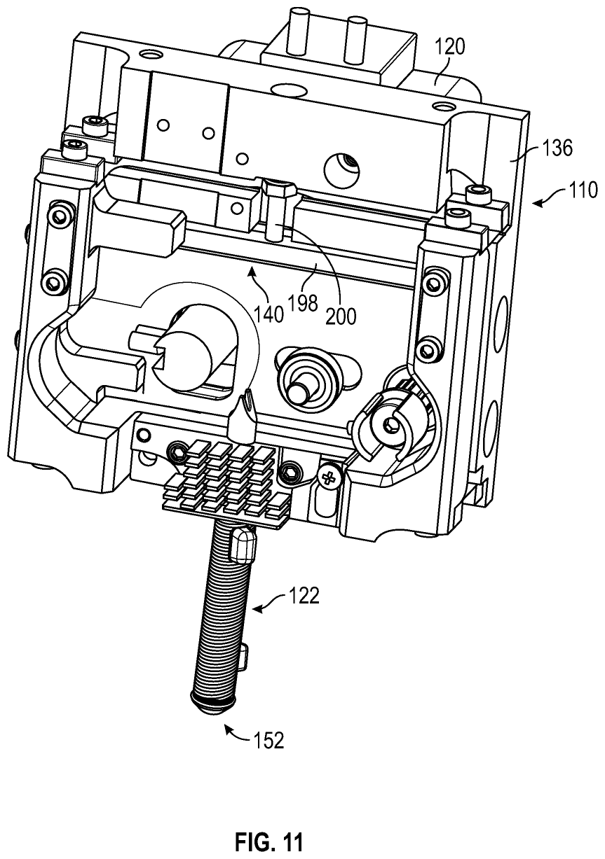

The present disclosure is directed to a printer head including a vertical height adjustment system for a nozzle. Referring now to FIG. 10, a three-dimensional printer head 110 and a support table 112 for a three-dimensional printer is illustrated. The printer head 110 includes a motor housing 118 containing a drive motor (not shown), a nozzle 122, a feed system 124, a z-axis plate assembly 126, a sensor assembly 128, an idle assembly 130, a receiver assembly 132, an adjustment knob 134, and a feed plate 136. FIG. 11 is an illustration of the printer head 110 shown in FIG. 10 where various components of the feed system 124, the idle assembly 130, the receiver assembly 132, and the adjustment knob 134 are removed to show a vertical height adjustment system 140 that is part of the printer head 110. As explained below, the disclosed vertical height adjustment system 140 includes an adjustment screw 200 that allows an operator to easily adjust a vertical position of the nozzle 122. It is to be appreciated that in some embodiments, a three-dimensional printer may include multiple printer heads 110. The disclosed vertical height adjustment system 140 provides for the fine adjustment that may be required by a dual-head three-dimensional printer so that the respective nozzles 122 of each printer head 110 are vertically aligned with one another. Specifically, referring to FIG. 10, in an embodiment the printer head 110 is aligned with the support table 112 by raising the support table 112 relative to the printer head 110.

Continuing to refer to FIG. 10, the feed system 124 feeds a filament (not shown) into the nozzle 122. In aspects, the filament includes thermoplastic materials, or materials that are at least partially thermoplastic, such as thermoplastic copolymers that may include cross-linked co-polymers. The nozzle 122 is mounted to the z-axis plate assembly 126. The z-axis plate assembly 126 allows the nozzle 122 to move in a z-axis or vertical direction relative to the support table 112 independently of the feed system 124, and the sensor assembly 128 indicates the location of the nozzle 122 relative to the support table 112.

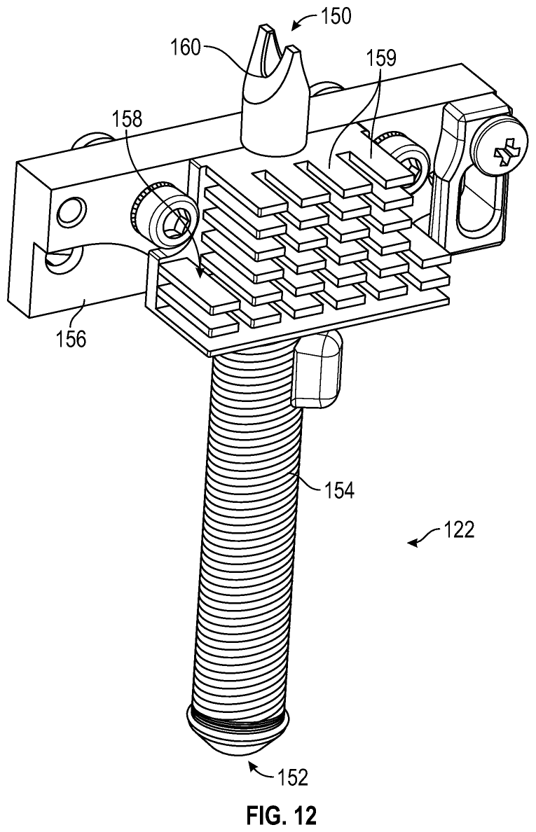

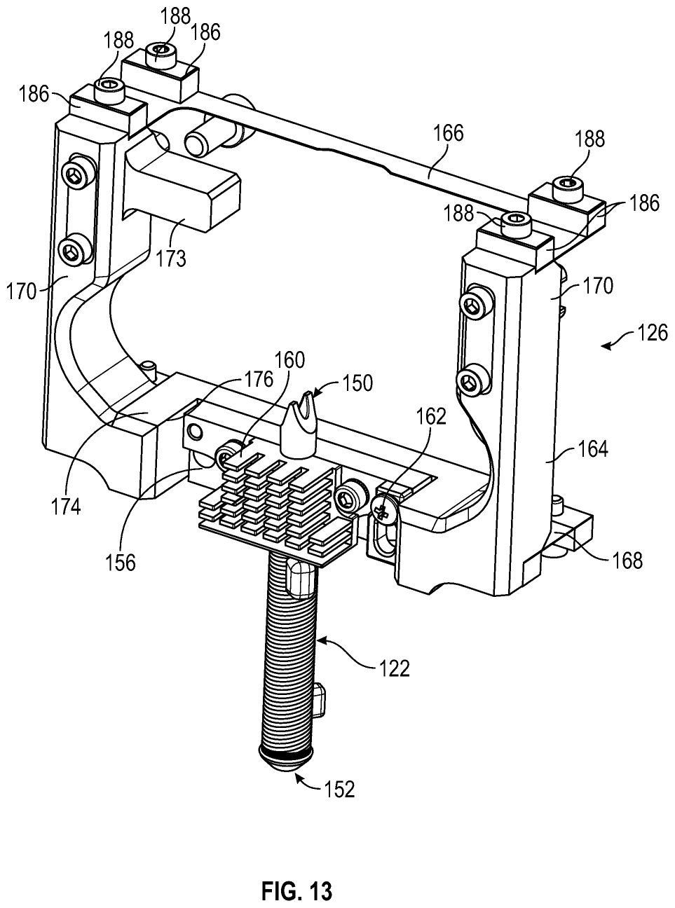

Referring now to FIG. 12, a perspective view of the nozzle 122 is shown. The nozzle 122 includes a feed end 150, a discharge end 152, a barrel 154, a nozzle clamp 156, and a heat sink 158 including a plurality of cooling fins 159. An opening 160 starts at the feed end 150, extends through a length of the barrel 154, and terminates at the discharge end 152 of the nozzle 122. The feed end 150 of the nozzle 122 receives a filament (not shown) through the opening 160. The barrel 154 includes an internal heating element such as a heater coil (not shown) that is heated by the barrel 154, and the heated filament exits the nozzle 122 through the discharge end 152. The nozzle 122 is affixed to the z-axis plate assembly 126 by the nozzle clamp 156 using one or more mechanical fasteners 162, which are shown in FIG. 13.

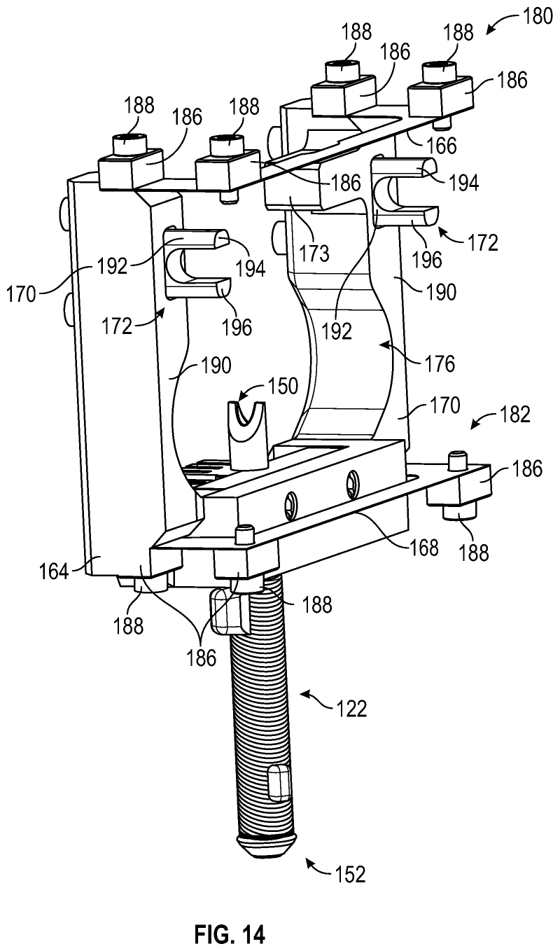

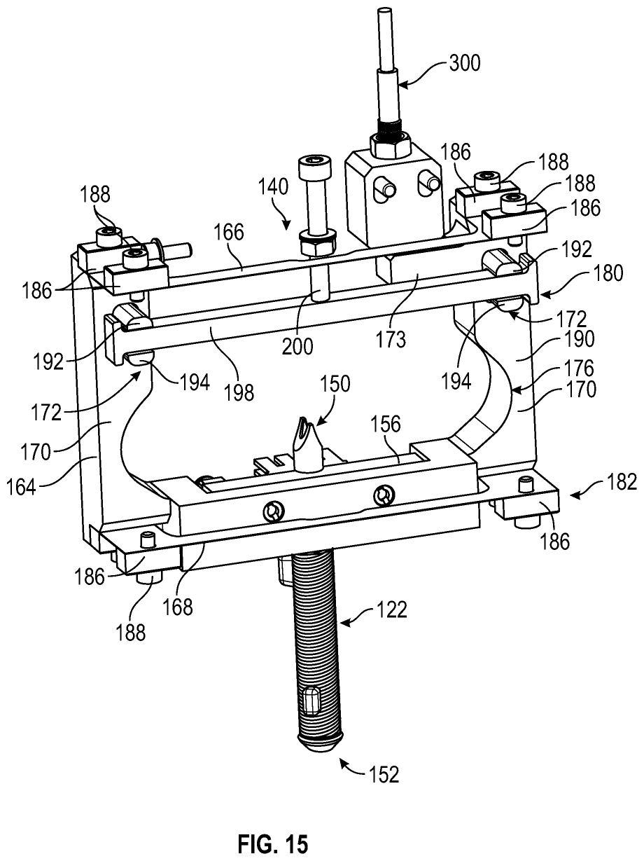

FIGS. 13 and 14 are an elevated perspective views of the nozzle 122 affixed to the z-axis plate assembly 126 by the mechanical fasteners 162. Referring to FIGS. 13 and 14, the z-axis plate assembly 126 includes a z-axis plate 164, a plurality of flexures 166, 168 and a plurality of tangs 172 (seen in FIG. 14). The z-axis plate 164 includes two side walls 170, an upper arm 173, and a lower wall 174. As explained below, the upper arm 173 of the z-axis plate 164 is positioned to contact an electromechanical position sensor 300 (seen in FIG. 15). The lower wall 174 extends in a horizontal direction and defines an opening 176 that is shaped to receive the nozzle clamp 156 of the nozzle 122.

Referring specifically to FIG. 14, a first flexure 166 is disposed along an upper portion 180 of the z-axis plate 164 and a remaining second flexure 168 is disposed along a lower portion 182 of the z-axis plate 164. The flexures 166, 168 are compliant members that are configured to affix the z-axis plate 164 to the feed plate 136 (seen in FIG. 10). In one non-limiting embodiment, the flexures 166, 168 are constructed of spring steel, however, it is to be appreciated that other metals and polymer materials may be used as well. The material that the flexures 166, 168 are constructed of, as well as a thickness of the flexures 166, 168, is selected based on a specific application, and is adjusted to provide a predetermined amount of opposing force when the z-axis plate assembly 126 is translated in an upward vertical direction. In one embodiment, the material of the flexures 166, 168 are selected to provide between about 9 Newtons to about 24 Newtons of opposing force when an operator lifts the z-axis plate assembly 126 in the upward vertical direction. Furthermore, although the figures illustrate two flexures 166, 168, it is to be appreciated that the figures are merely exemplary in nature, and the printer head 110 may include more than two flexures 166, 168 as well. As seen in FIG. 14, the flexures 166, 168 are attached to the feed plate 136 (FIG. 10) and the z-axis plate 164 by a plurality of blocks 186 and mechanical fasteners 188.

Continuing to refer to FIG. 14, in the embodiment as shown the printer head 110 includes two tangs 172 disposed along rear surfaces 190 of the side walls 170 of the z-axis plate 164. Specifically, FIG. 14 illustrates a single tang 172 is disposed on each side wall 170. Each tang 172 includes a body 192 defining an upper stop 194 and a lower stop 196. As seen in FIG. 15, the tangs 172 are configured to receive a lifting bar 198, which is part of the vertical height adjustment system 140. The lifting bar 198 is received between the upper stop 194 and the lower stop 196 of each tang 172. As explained below, the lifting bar 198 is used to urge or move the z-axis plate 164 in the upward vertical direction. Since the nozzle clamp 156 of the nozzle 122 is attached to the z-axis plate 164, it follows that the nozzle 122 is also moved in the upward vertical direction as well.

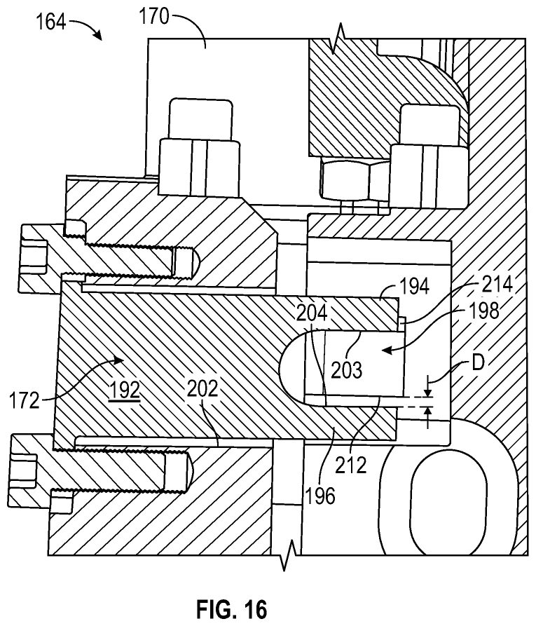

FIG. 16 is a cross-sectioned enlarged view of one of the side walls 170 of the z-axis plate 164, which illustrates the tang 172 engaged with the z-axis plate 164. As seen in FIG. 16, in one embodiment the tang 172 is received within a respective recess located within the z-axis plate 164. In embodiment as shown in FIG. 16, the tangs 172 are constructed from a different material than the z-axis plate 164. For example, in one embodiment, the z-axis plate 164 may be constructed from aluminum or an aluminum based alloy, and the tangs 172 are constructed from steel. Steel may be used for the tangs 172 since steel deforms less easily than aluminum. Furthermore, because the tangs 172 are received within respective recesses 102 of the z-axis plate 164, it may be possible to individually adjust the position of each tang 172. Although FIG. 16 illustrates the tangs 172 as separate components, it is to be appreciated that in another embodiment, the z-axis plate 164 and the tangs 172 are part of the same component.

FIG. 16 also illustrates the lifting bar 198 received by one of the tangs 172. Each tang 172 defines a total distance D that the lifting bar 198 travels along to adjust the vertical position of the nozzle 122 (FIG. 10). Specifically, the lifting bar 198 travels between the upper stop 194 and the lower stop 196 of the tang 172 to adjust the vertical position of the nozzle 122. As seen in FIG. 16, the upper stop 194 of the tang 172 defines an upper surface 103 and the lower stop 196 of the tang 172 defines a lower surface 104, and the upper and lower surfaces 103, 104 of the tang 172 limit movement of the lifting bar 198 in the vertical direction. The total distance D that the lifting bar 198 may travel along is measured between the lifting bar 198 and either the upper stop 194 or the lower stop 196 of the tang 172. Specifically, in the embodiment as shown in FIG. 16, the total distance D is measured between a bottom surface 212 of the lifting bar 198 and the lower surface 104 of the tang 172. Alternatively, the total distance D may also be measured between a top surface 114 of the lifting bar 198 and the upper surface 103 of the tang 172.

The total distance D that the lifting bar 198 travels to adjust the vertical height of the nozzle 122 is based on particular configuration and layout of the feed system 124 (seen in FIG. 10) as well as the specific tolerance of the electromechanical position sensor 300 (shown in FIG. 15). In one example, the total distance D is about 0.7 millimeters, however, it is to be appreciated that this measurement is merely exemplary in nature. In the example as shown in FIG. 16, the lifting bar 198 is abuts against the upper surface 103 of the tang 172, and the nozzle 122 (FIG. 10) is positioned in a maximum upward vertical position. However, the spacing of the flexures 166, 168 (seen in FIG. 15) is such that a minimum downward pre-load force is exerted upon the lifting bar 198. The minimum downward pre-load force is configured to reduce or minimize vibration of the nozzle 122.

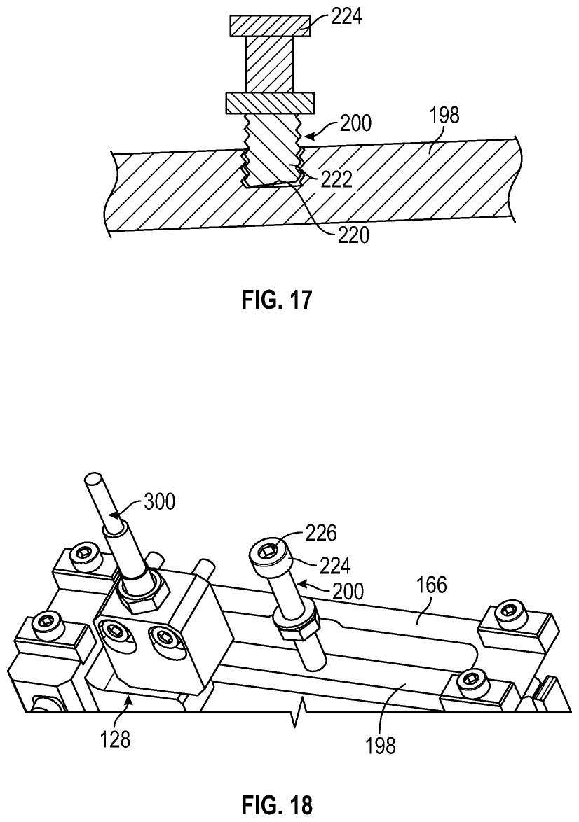

Referring to FIG. 15, the vertical height adjustment system 140 further includes an adjustment screw 200 that is threadingly engaged with the lifting bar 198, where rotation of the adjustment screw 200 results in the lifting bar 198 being moved upward and downward in the vertical direction. Specifically, as seen in FIG. 17, the lifting bar 198 defines a threaded aperture 220 for receiving a threaded shank 222 of the adjustment screw 200. The shank 222 of the adjustment screw 200 rotates within the threaded aperture 120 of the lifting bar 198 to move the lifting bar 198 either upward or downward. As seen in FIG. 18, in one embodiment a head 224 of the adjustment screw 200 may include a hexagonal opening 226. Accordingly, an operator may use a tool such as a hex key to easily rotate the adjustment screw 200.

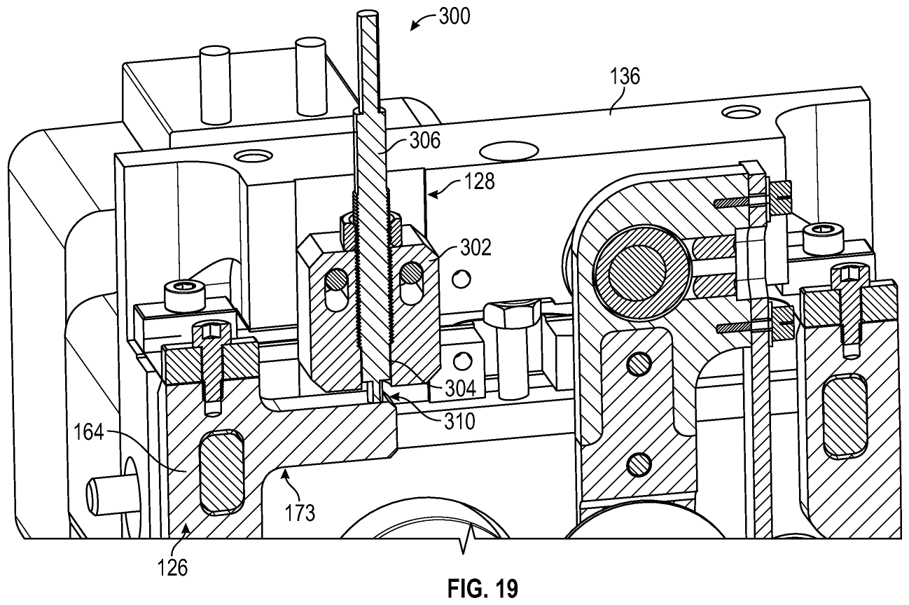

Referring now to FIG. 19, a cross-sectioned view of the sensor assembly 128 including the electromechanical position sensor 300 is shown. The electromechanical position sensor 300 determines the height of the z-axis plate 164 relative to the support table 112 (shown in FIG. 10). The sensor assembly 128 includes a sensor bracket 302 that is coupled to the feed plate 136. As seen in FIG. 19, the sensor bracket 302 defines a bore 304. The electromechanical position sensor 300 includes a plunger 306 that is received by the bore 304 of the sensor bracket 302. As seen in FIG. 19, the electromechanical position sensor 300 is triggered when a bottom portion 310 of the plunger 306 contacts the upper arm 173 of the z-axis plate 164. When the electromechanical position sensor 300 is triggered, this indicates that something has contacted the discharge end 152 of the nozzle 122.

Referring to both FIGS. 10 and 19, when the discharge end 152 of the nozzle 122 contacts the support table 112, this in turn causes the z-axis plate 164 to move in the upward vertical direction. As a result, the upper arm 173 of the z-axis plate 164 contacts the bottom portion 310 of the plunger 306 of the electromechanical position sensor 300. It is to be appreciated that once the electromechanical position sensor 300 is triggered, the three-dimensional printer may stop the support table 112 from continuing to move in the upward vertical direction.

Referring generally to the figures, the disclosed printer head provides various technical effects and benefits. Specifically, the vertical height adjustment system of the disclosed printer head provides a simple, readily accessible approach for an operator to change the vertical height of the nozzle, without the need to remove the entire printer head. Furthermore, the vertical height adjustment system provides for the fine adjustment that may be required by a dual-head three-dimensional printer so that the respective nozzles of each printer head are vertically aligned with one another. The fine adjustment is performed by a single screw, instead of multiple screws that some current systems may require.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A three-dimensional printer head, comprising:
a receiver assembly including a main body divided into a front section and a rear section, wherein the front section of the main body is independently rotatable of the rear section of the main body, and wherein the main body of the receiver assembly defines:
a feed opening;
a discharge opening; and
a passageway that extends between the feed opening and the discharge opening of the main body.

2. The three-dimensional printer head of claim 1, wherein the front section of the main body is rotatably secured to the rear section of the main body by a mechanical fastener.

3. The three-dimensional printer head of claim 2, wherein an axis of rotation of the front section of the main body coincides with the mechanical fastener.

4. The three-dimensional printer head of claim 2, wherein the front section of the main body includes a countersunk aperture for receiving the mechanical fastener.

5. The three-dimensional printer head of claim 4, further comprising one or more biasing members seated against a shelf of the countersunk aperture.

6. The three-dimensional printer head of claim 5, wherein the one or more biasing members are disk springs.

7. The three-dimensional printer head of claim 1, wherein the passageway of the receiver assembly includes an entry portion, a converging portion, a reduced diameter portion, and a diverging portion.

8. The three-dimensional printer head of claim 7, further comprising a nozzle includes a discharge opening, wherein the nozzle heats a filament, and the filament exits the printer head through the discharge opening of the nozzle.

9. The three-dimensional printer head of claim 8, wherein the diverging portion of the passageway is sized to allow the filament that has expanded due to heating by the nozzle to travel back into the passageway.

10. A three-dimensional printer head, comprising:
a nozzle;
a z-axis plate assembly including a z-axis plate, wherein the nozzle is attached to the z-axis plate; and
a vertical height adjustment system configured to move the nozzle in an upward vertical direction, the vertical height adjustment system comprising:
a lifting bar configured to travel along a total distance to adjust a vertical position of the nozzle; and
a plurality of tangs that are part of the z-axis plate, wherein each tang includes an upper stop and a lower stop that define the total distance that the lifting bar travels.

11. The three-dimensional printer head of claim 10, wherein the lifting bar is received between the upper stop and the lower stop of each tang.

12. The three-dimensional printer head of claim 10, wherein the z-axis plate is constructed of an aluminum based alloy and the plurality of tangs are constructed from steel.

13. The three-dimensional printer head of claim 10, further comprising an adjustment screw that is threadingly engaged with the lifting bar.

14. The three-dimensional printer head of claim 13, wherein rotation of the adjustment screw results in the lifting bar being moved either upward or downward.

15. The three-dimensional printer head of claim 10, further comprising a first flexure disposed along an upper portion of the z-axis plate and a second flexure disposed along a lower portion of the z-axis plate.
